(19) United States
(12) Patent Application Publication
(10) Pub. No.: US 2009/0006401 A1
(43) Pub. Date: Jan. 1, 2009

(54) FILE MONITORING METHOD, SYSTEM, AND PROGRAM PRODUCT

(76) Inventors: Gregg A. Davis, Raleigh, NC (US); Joseph J. Lee, Holly Springs, NC (US)

Correspondence Address: HOFFMAN WARNICK LLC, 75 STATE ST, 14TH FLOOR, ALBANY, NY, 12207, US

(21) Appl. No.: 11/769,075

(22) Filed: Jun. 27, 2007

(51) Int. Cl. G06F 17/30

(52) U.S. Cl. 707/8; 707/E17.007

(57) ABSTRACT

The present invention provides a file monitoring approach that runs on bridge servers in an SNI environment, monitors a defined folder and detects the same file existing (by its file name persisting) for a predetermined interval period or longer. Optionally, the program can attempt to unlock the ticket corresponding to the inbound update. It also sends notification of the condition to bridge support. If the option to unlock the ticket is used, it reports on the success or failure of the attempt to unlock the ticket in the notification sent. One advantage of using this approach is to automatically detect when this condition is occurring to avoid bridge log space problems, possible customer calls to a helpdesk to request tickets be unlocked, and to notify bridge support. This approach helps to automate bridge support.

### FIELD OF THE INVENTION

The present invention generally relates to file monitoring. Specifically, the present invention monitors update files for tickets to detect and address the tickets being locked.

### BACKGROUND OF THE INVENTION

In many instances of bridge inbound processing folders, XML files cannot be processed by the bridge while a ticket corresponding to an inbound update is locked by a user (e.g., the user is editing the ticket in a GUI tool or the like). While this is the case, the bridge checks the ticket for locked status each inbound processing cycle. Under normal circumstances the user would eventually save their changes or cancel, the ticket would be unlocked, and the bridge would process the inbound update. However, due to network failures or abnormal GUI software terminations the ticket may remain locked permanently, thereby creating an infinite bridge processing loop and causing the bridge logs to grow excessively large. Multiple bridges running on the same server having the same condition concurrently may expire bridge log space thereby interrupting bridge service for all bridges on that server. Also during this period, users that need to update the ticket cannot do so and must call a helpdesk to request the ticket be unlocked. This solution thereby prevents the necessity for some helpdesk calls that would otherwise occur. This condition cannot be detected by examining the inbound XML file's modification date/time because the bridge processing attempt changes it each bridge inbound processing execution cycle. There are no other known solutions to this problem. In view of the foregoing, there exists a need for an approach that solves at least one of the deficiencies in the related art.

### SUMMARY OF THE INVENTION

In general, the present invention provides a file monitoring approach (e.g., in the form of a Java application in one embodiment) that runs on bridge servers in the SNI environment, monitors a defined folder and detects the same file existing (by its name persisting, not by the file's modification date/time) for the defined interval period or longer. Optionally, the program can attempt to unlock the ticket corresponding to the inbound update. It sends notification of the condition to bridge support by use of (e.g., the sdc_emailer) Java application. If the option to unlock the ticket is used, it reports on the success or failure of the attempt to unlock the ticket in the notification sent. One advantage of using this approach is to automatically detect when this condition is occurring to avoid bridge log space problems, possible customer calls to a helpdesk to request tickets be unlocked, and to notify bridge support. The option to automatically handle the likely issue causing the condition, and to send the success or failure of the attempt along with the notification, automates bridge support.

A first aspect of the present invention provides a file monitoring method, comprising: detecting an update for a ticket, the update having a file name; determining whether the ticket is locked based on at least one previous detection of the update; and taking a corrective action in response to the ticket being locked.

A second aspect of the present invention provides a file monitoring system, comprising: a module for detecting an update for a ticket, the update having a file name; a module for determining whether the ticket is locked based on at least one previous detection of the update; and a module for taking a corrective action in response to the ticket being locked.

A third aspect of the present invention provides a program product stored on a computer readable medium for monitoring files, the computer readable medium comprising program code for causing a computer system to: detect an update for a ticket, the update having a file name; determine whether the ticket is locked based on at least one previous detection of the update; and take a corrective action in response to the ticket being locked.

A fourth aspect of the present invention computer software embodied in a propagated signal for monitoring files, the computer software comprising instructions for causing a computer system to: detect an update for a ticket, the update having a file name; determine whether the ticket is locked based on at least one previous detection of the update; and take a corrective action in response to the ticket being locked.

A fifth aspect of the present invention provides a method for deploying a system for monitoring files, comprising: providing a computer infrastructure being operable to: detect an update for a ticket, the update having a file name; determine whether the ticket is locked based on at least one previous detection of the update; and take a corrective action in response to the ticket being locked.

A sixth aspect of the present invention provides a computer-implemented file monitoring business method, comprising: detecting an update for a ticket, the update having a file name; determining whether the ticket is locked based on at least one previous detection of the update; and taking a corrective action in response to the ticket being locked.

A seventh aspect of the present invention provides a data processing system for monitoring files, comprising a memory medium having instructions; a bus coupled to the memory medium; and a processor coupled to the bus that when executing the instructions causes the data processing system to: detect an update for a ticket, the update having a file name, determine whether the ticket is locked based on at least one previous detection of the update, and take a corrective action in response to the ticket being locked.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a method flow diagram according to the present invention

FIG. 2 depicts computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the detailed description of the invention has the following sections:

I. General Description

II. Illustrative Implementation

III. Computerized Implementation

### I. General Description

As indicated above, the present invention provides a file monitoring approach (e.g., in the form of a Java application in one embodiment) that runs on bridge servers in the SNI environment, monitors a defined folder and detects the same file existing (by its name persisting, not by the file's modification date/time) for the defined interval period or longer. Optionally, the program can attempt to unlock the ticket corresponding to the inbound update. It also sends notification of the condition to bridge support by use of (e.g., the sdc_emailer) Java application. If the option to unlock the ticket is used, it reports on the success or failure of the attempt to unlock the ticket in the notification sent. One advantage of using this approach is to automatically detect when this condition is occurring to avoid bridge log space problems, possible customer calls to a helpdesk to request tickets be unlocked, and to notify bridge support. The option to automatically handle the likely issue causing the condition, and to send the success or failure of the attempt along with the notification, automates bridge support.

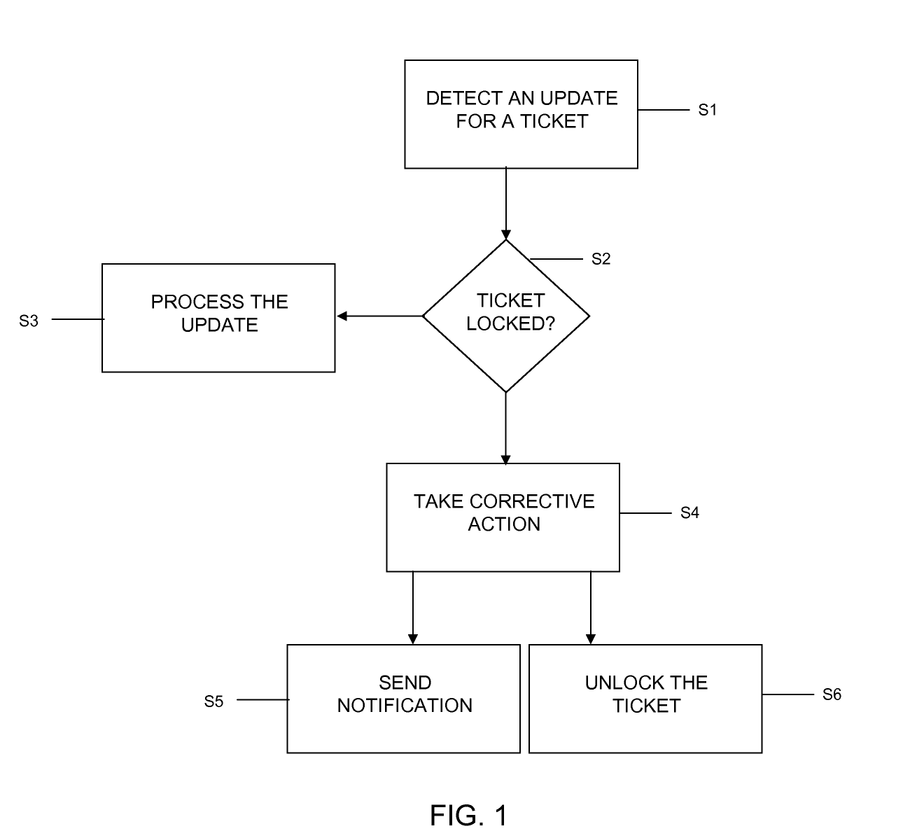

Referring to FIG. 1, a method flow diagram according to the present invention is shown. As shown in step S1, an update for a ticket is received. In step S2, it is determined whether the ticket is locked. Under the present invention, this can be done in a number of ways. In one embodiment, it is done based on at least one previous detection of the update as determined based on a file name of the update. For example, a file in a folder containing the ticket update can be examined. The file name of the update will be compared against a set (e.g., at least one) of file names previously detected for the ticket as stored in a folder. The ticket will be determined to be locked if the update has been previously detected and a query to unlock it (conditionally) is successful.

In any event, if the ticket is not determined to be locked in step S2, the update could be processed in step S3. However, if the ticket is locked, corrective action(s) could be taken in step S4. As depicted, such corrective action(s) could include sending a notification in step S5 and/or unlocking the ticket in step S6. Still yet, in taking the corrective action(s), the factors of time and/or processing cycles could also be utilized. For example, the corrective action(s) could be taken only if the ticket has been locked for a length of time and/or number of processing cycles that exceeds a predetermined threshold.

### II. Illustrative Implementation

The foregoing is intended as a more specific illustrative example/implementation of the present invention. Certain monikers and terms are used herein for illustrative purposes only. Along these lines, the name SameFileNotifMon (as used herein) stands for Same File (detected multiple times such as twice) Notification Monitor. It was created to send notification for the same file name and extension existing in the specified folder for two or more executions, or a complete monitor interval. This was primarily created to detect bridge inbound folder files for tickets that have been locked excessively long, thereby causing the bridge log to grow excessively large. Because the modification date/time of the file is updated by the bridge each bridge cycle, the file's modification date/time cannot be used to determine the file's age.

This application also takes advantage of an Sdc_emailer application to send the notification. When the same file (or files) is detected in the specified folder through two execution cycles (a complete monitor interval), notification criteria is met. SameFileNotifMon then connects to the database and inserts a row (or rows) in the database table SEND_NOTIFICATION where Sdc_emailer picks it up and sends the email. The .properties file specifies the database, the database userid and password, the path of the folder to monitor, and the interval the program executes to examine the folder contents. This interval would be the minimum time that the same file name and extension can exist (or tickets can be locked) and trigger notification. For example, if monitorIntervalInMinutes=120 then notification criteria is met for files between 2 and 4 hours of age at the time the monitor executes. Folders within the folder being monitored are ignored. Only files will trigger notification.

The program is able to parse the ticket number from the file meeting criteria, and, optionally attempt to unlock the ticket by connecting to the bridge application database and running a supplied query, substituting “-PROBLEM_ID-” with the ticket number parsed from the file. Additionally, when autounlock=yes the success or failure of the query execution to attempt to unlock the ticket is sent in the notification. See the properties file documentation and supplied example for details.

### The .Properties File

The .properties file is used for setting the application variables. It can be named anything, but must contain the variable values listed below and must be passed to the application at invocation. (For example: java SameFileNotifMon LocationALockedTickets.properties) In this way, multiple instances of the application may be executed while each performs a different function. Since the properties are read at the beginning of each execution cycle the values may be changed while the program is executing to change its behavior for the next execution cycle. Briefly, the variables are as follows:
autoUnlock=Yes or No. If “yes” and ticket meets criteria, the application will attempt connection to the application database and run the supplied query to attempt to unlock the ticket. This value is not case sensitive.
app_userid=Bridge userid or other used to connect to the database for this bridge. Required only if autoUnlock=yes.
app_password=Password for the above app_userid. Required only if autoUnlock=yes.
app_database=The database for this bridge. (See database value format under database below. Required only if autounlock=yes.
app_driver=COM.xyz.db2.jdbc.app.DB2Driver (A constant value for now.) Required only if autounlock=yes.
autoUnlockQuery=The query to unlock the ticket. “-PROBLEM_ID-” is replaced with the problem_id parsed from the file that meets criteria. See an example query in the properties file. Required only if autounlock=yes. ticketNumberXMLTag must also be set in properties. The problem_id value parsed from the file is scrutinized before use in this query.
userid=Notification database (EUA7 DB2A) userid. CLAS requested ESMVS7 userid.
password=password for the userid above.
database=jdbc:db2:eua7 db2a (A constant value for now.)
driver=COM.xyz.db2.jdbc.app.DB2Driver (A constant value for now.)
view=igsview (A constant value for now. Using CLAS, request to connect the userid above to RACF group IGSGRP for privileges to this view.)
to =pin@skytel.com,email@us.xyz.com (Notification email addresses separated by commas as in this example.)
path=Path of the folder to be monitored. (For example: D:/XMLBridge/ZFD/inbound/)
monitorIntervalInMinutes=An integer value of the monitor interval in minutes. The same file ID existing in the folder for this period or greater will trigger notification.
title=The monitor title or subject line of email (for example: LocationA Locked Ticket>2 hours)

ticketNumberXMLTag=The XML tag in this schema containing the ticket number (or problem_id) value so that it may be parsed out for use in the notification and optional query to auto-unlock the ticket.

### A Batch File

A Batch file (.BAT) may be created to call the Java application and to specify a log file for piping of the output messages. In the following example the date and time is printed to the output file when the application is started.

LocationALockedTicketsMonitor.bat contents:
If exist LocationALockedTickets.log copy /y LocationALockedTickets.log
LocationALockedTickets.previous.log
If exist LocationALockedTickets.log erase LocationALockedTickets.log
echo LocationA Locked Tickets Monitor started: %DATE% %TIME%>>

### LocationALockedTickets.log

java SameFileNotifMon LocationALockedTickets.properties>>

### LocationALockedTickets.log

After creation of the batch file, it should be tested from a command window. The execution can be stopped using the Ctrl-c key combination.

### The Log File

Execution of the preceding batch file will produce a log file named LocationALockedTickets.log with contents similar to the following:

LocationA Locked Tickets Monitor started: Sun Jul. 9, 2006 01:02:52.79

Jul. 9, 2006 03:02:52 AM: no files detected.

Jul. 9, 2006 05:02:52 AM: no files detected.

Jul. 9, 2006 07:02:52 AM: no files detected.

Files detected: Jul. 9, 2006 09:02:52 PM Ticket: XYZ-00510137

Query Issued: update esmu.problems set active_with=null where active_with is not null and active_with !=‘ZFDXMLT’ and problem_id=‘XYZ-00510137’;

Ticket: XYZ-00510137 successfully unlocked.

Jul. 9, 2006 11:02:52 AM: no files detected.

Jul. 9, 2006 01:02:52 PM: no files detected.

The properties file in this case had monitorIntervalInMinutes=120, autoUnlock=yes, and the unlockQuery=“Query Issued:” shown above. Note that the application reports if files are or are not detected that meet notification criteria for each execution interval. The application reports if the query execution to unlock the ticket succeeded (or not) if autoUnlock=yes. The same message is also sent in the body of the notification. Also note that SameFileNotifmon does not (cannot) report until the completion of one interval, or the second execution to examine the folder contents. This is because it identifies persisting file names from one execution to the next, not file modification timestamps of a particular age.

### Starting the Monitors

Windows Task Scheduler can be used to schedule the .BAT file to execute when the server starts. To start execution right away, Task Scheduler can be used to schedule it to run just once. Within Task Scheduler, on the Settings tab, remove the checkmark in the box indicating to “Stop the task if it runs for:” This is because the applications run in an infinite loop, sleeping for the specified period (.properties file monitorIntervalInMinutes value) following each execution to examine the folder contents.

### Example Tasks:

LocationA Locked Tickets Monitor (scheduled to start when the server is started)
LocationA Locked Tickets Monitor Startup (scheduled to start in 5 minutes . . . following logoff.)

### Stopping the Monitors

If the task needs to be stopped for some reason (maybe you need to stop the notifications for a known issue), this can be accomplished via Task Scheduler (sometimes) or Terminal Services Manager (Processes tab.) Also, since the application reads the properties each execution cycle, the properties file (monitorIntervalInMinutes value) may be altered to put the application to sleep until the next server reboot or longer, essentially disabling it.

### Performance Benchmarks

Since both of these applications write to the log file for each execution cycle, performance can be measured by examining the logs.

SameFileNotifMon executed 51 times in 1 second elapsed time which included sending a single notification twice. In other words, the execution cycle took 1/51^{st} of a second on average for each monitor interval. This includes the time to read the properties, examine the folder contents, compare with the folder contents from the previous execution, twice connecting to the database, inserting a row, disconnecting from the database, and writing to the log.

### III. Computerized Implementation

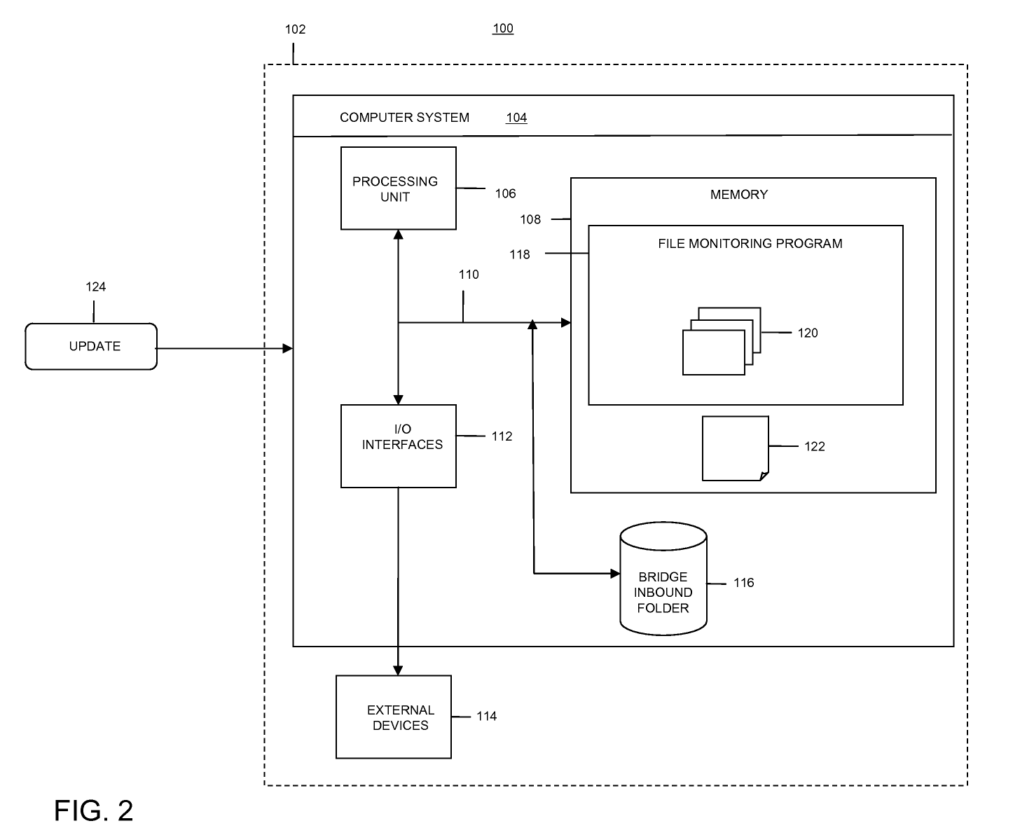

Referring now to FIG. 2, a computerized implementation 100 of the present invention is shown. As depicted, implementation 100 includes bridge server 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

As shown, bridge server 104 includes a processing unit 106, a memory 108, a bus 110, and input/output (I/O) interfaces 112. Further, bridge server 104 is shown in communication with external I/O devices/resources 114 and bridge inbound folder 116. In general, processing unit 106 executes computer program code, such as file monitor program 118, which is stored in memory 108 and/or bridge inbound folder 116. While executing computer program code, processing unit 106 can read and/or write data to/from memory 108, bridge inbound folder 116, and/or I/O interfaces 112. Bus 110 provides a communication link between each of the components in bridge server 104. External devices 114 can comprise any devices (e.g., keyboard, pointing device, display, etc.) that enable a user to interact with bridge server 104 and/or any devices (e.g., network card, modem, etc.) that enable bridge server 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, bridge server 104 is only representative of various possible computer systems that can include numerous combinations of hardware. To this extent, in other embodiments, bridge server 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server.

Similarly, memory 108 and/or bridge inbound folder 116 can comprise any combination of various types of data storage and/or transmission media that reside at one or more physical locations. Further, I/O interfaces 112 can comprise any module for exchanging information with one or more external device 114. Still further, it is understood that one or more additional components (e.g., system software, math co-processing unit, etc.) not shown in FIG. 2 can be included in bridge server 104. However, if bridge server 104 comprises a handheld device or the like, it is understood that one or more external devices 114 (e.g., a display) and/or bridge inbound folder 116 could be contained within bridge server 104, not externally as shown.

Bridge inbound folder 116 can be any type of system capable of providing storage for information under the present invention. To this extent, bridge inbound folder 116 could include one or more storage devices, such as a magnetic disk drive or an optical disk drive. In another embodiment, bridge inbound folder 116 includes data distributed across, for example, a local area network (LAN), wide area network (WAN) or a storage area network (SAN) (not shown). In addition, although not shown, additional components, such as cache memory, communication systems, system software, etc., may be incorporated into bridge server 104.

Shown in memory 108 of bridge server 104 are: set (at least one) of tickets 122, set of bridges 124, and file monitor program 118 that includes a set (at least one) of modules 120. The modules generally provide the functions of the present invention as described herein. Specifically (among other things), multiple bridges 124 can run on bridge server 104. As this occurs, set of modules 120 is configured to: detect an update 126 for a ticket 122; and determine whether ticket 122 is locked. As indicated above, this can be done in a number of ways. In one embodiment, it is done based on at least one previous detection of update 126 as determined based on a file name of the update. For example, a file for the ticket 122 in bridge inbound folder 116 can be examined. The file name of update 126 will be compared against a set (e.g., at least one) of file names previously detected for ticket 122 as stored in the folder of bridge inbound folder 116. Ticket 122 will be determined to be locked if update 126 has been previously detected a predetermined number of times (e.g., one or more times).

In any event, if ticket 122 is not determined to be locked, set of modules 120 is configured to process update 126 (or have update 126 processed by another program). However, if ticket 122 is locked, set of modules 120 is configured to take corrective action(s). Such corrective action(s) could include sending a notification 128 and/or unlocking ticket 122. Still yet, in taking the corrective action(s), the factors of time and/or processing cycles could also be utilized. For example, set of modules could be configured to take the corrective action(s) only if the ticket has been locked for a length of time based on the processing interval duration.

While shown and described herein as a method, system, and program product for monitoring files, it is understood that the invention further provides various alternative embodiments. For example, in one embodiment, the invention provides a computer-readable/useable medium that includes computer program code to enable a computer infrastructure to monitor files. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 2) and/or bridge inbound folder 116 (FIG. 2) (e.g., a fixed disk, a read-only memory, a random access memory, a cache memory, etc.), and/or as a data stream (e.g., a propagated stream) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to monitor files. In this case, the service provider can create, maintain, support, etc., a computer infrastructure, such as computer infrastructure 102 (FIG. 2) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented business method for monitoring files. In this case, a computer infrastructure, such as computer infrastructure 102 (FIG. 2), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as bridge server 104 (FIG. 2), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A file monitoring method, comprising:
detecting an update for a ticket, the update having a file name;
determining whether the ticket is locked based on at least one previous detection of the update; and
taking a corrective action in response to the ticket being locked.

2. The file monitoring method of claim 1, the determining comprising:
comparing the file name to a set of file names of updates previously detected the set of file names presently detected; and determining that the ticket is locked if the update has been previously detected.

3. The file monitoring method of claim 1, the at least one previous detection of the update corresponding to a length of time that the ticket has been locked, the corrective action being taken if the length of time exceeds a predetermined threshold.

4. The file monitoring method of claim 1, the taking comprising sending a notification that the ticket is locked.

5. The file monitoring method of claim 1, the taking comprising unlocking the ticket.

6. A file monitoring system, comprising:
a module for detecting an update for a ticket, the update having a file name;
a module for determining whether the ticket is locked based on at least one previous detection of the update; and
a module for taking a corrective action in response to the ticket being locked.

7. The file monitoring system of claim 6, the module for determining being configured to:
compare the file name to a set of file names of updates previously received; and
determine that the ticket is locked if the update has been previously detected.

8. The file monitoring system of claim 6, the at least one previous detection of the update corresponding to a length of time that the ticket has been locked, the corrective action being taken if the length of time exceeds a predetermined threshold.

9. The file monitoring system of claim 6, the module for taking being configured to send a notification that the ticket is locked.

10. The file monitoring system of claim 6, the module for taking being configured to unlock the ticket.

11. A program product stored on a computer readable medium for monitoring files, the computer readable medium comprising program code for causing a computer system to:
detect an update for a ticket, the update having a file name;
determine whether the ticket is locked based on at least one previous detection of the update; and
take a corrective action in response to the ticket being locked.

12. The file monitoring method of claim 11, the computer readable medium further comprising program code for causing the computer system to:
compare the file name to a set of file names of updates previously detected; and
determine that the ticket is locked if the update has been previously detected.

13. The program product of claim 11, the at least one previous detection of the update corresponding to a length of time that the ticket has been locked, the corrective action being taken if the length of time exceeds a predetermined threshold.

14. The program product of claim 11 the computer readable medium further comprising program code for causing the computer system to send a notification that the ticket is locked.

15. The program product of claim 11 the computer readable medium further comprising program code for causing the computer system to unlock the ticket.
